(19) United States
(12) Patent Application Publication
(10) Pub. No.: US 2023/0177151 A1
(43) Pub. Date: Jun. 8, 2023

(54) SYSTEM AND METHOD OF MICROCONTROLLER SECURITY

(71) Applicant: One Tech Inc., Irving, TX (US)

(72) Inventors: Yasser Khan, Dallas, TX (US); Yandong Zhang, Plano, TX (US); Wei Guo, Anna, TX (US)

(21) Appl. No.: 17/643,118

(22) Filed: Dec. 7, 2021

(51) Int. Cl. G06F 21/55; G06K 9/62

(52) U.S. Cl. CPC G06F 21/552; G06F 21/554; G06K 9/6256

(57) ABSTRACT

A software based MCU security system using artificial intelligence (“AI”) technology is disclosed. The MCU security system comprises a training module where training datasets are processed and an inference module where real-time or live data are provided to predict and examine if the current behavior of the network or system being monitored are within the normal range. If abnormality is detected, alarm is sent to a server for further handle the abnormality.

### TECHNICAL FIELD

Examples of the present disclosure relate generally to microcontroller unit (“MCU”) security system. More particularly, but not by way of limitation, the present disclosure relates to a software based MCU security system using artificial intelligence (“AI”) technology.

### BACKGROUND

In recent years, single board computers using microcontroller units (“MCU”) have been rapidly developing and widely deployed in many applications. MCUs are small computers on Metal-Oxide-Semiconductor (MOS) chips. MCUs have many advantages over many other types of computers due to their ready availability, small size, low cost, ease to interface additional RAM, ROM, and I/O ports, among other advantages. MCUs are broadly used in automatically controlled products and devices, such as automobile engine control systems, implantable medical devices, remote controls, office machines, appliances power tools and other embedded systems. MCUs are also broadly used in internet of things (“IOTs”) as edge devices thanks to their low cost and popularity in data collection, sensing and actuating.

With their increased popularity, security of the MCU computers becomes a pressing issue. Due to their very limited processor capacity and small memory, most security software cannot run on the MCU computers.

### BRIEF DESCRIPTION OF THE DRAWINGS

To easily identify the discussion of any particular element or act, the most significant digit or digits in a reference number refer to the figure number in which that element is first introduced.

In the drawings, which are not necessarily drawn to scale, like numerals may describe similar components in different views. Like numerals having different letter suffixes may represent different instances of similar components. Some examples are illustrated by way of example, and not limitation, in the figures of the accompanying drawings in which:

FIG. 1 is a schematic diagram of a single board computer using MCU according to an example of the present application.

FIG. 2 is an exemplary schematic view of the MCU security system data flow.

FIG. 3 is a flowchart of the MCU security system in inference mode.

FIG. 4 is a flow chart of the initiation process of the MCU security system.

FIG. 5a-5b illustrates the training set segmentation and center calculation

FIG. 6 illustrates the training process of the MCU security system according to an example of the present application.

FIG. 7 illustrates the inference process of the MCU security system according to an example of the present application.

### DETAILED DESCRIPTION

Methods and systems for a software based MCU security system based on AI technology are disclosed. Various aspects are disclosed in the following description and related drawings to show specific examples relating to exemplary embodiments. Alternate embodiments will be apparent to those skilled in the pertinent art upon, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should be construed to limit any embodiments disclosed herein. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, steps, operations, elements, and/or components, but do not preclude the presence or addition of one or more other features, integers, steps, operations, elements, components, and/or groups thereof.

The present application discloses a software based MCU security system. The MCUs usually includes small memory/storage space with limited computational power. Typically, the MCU is used to implement dedicated functions repeatedly. Traditional software-based security approaches are mostly not suitable for the MCUs because of their hardware limitations. For example, most antivirus software is based on the data identification technique. First, the virus' “fingerprints” are collected and stored. Then by scanning the data in the storage and in the memory, malware may be identified and dealt with. However, these types of security techniques are not practical for MCUs because they require high computational and storage cost.

The software-based MCU security system of the present application uses machine-learning techniques to solve the problems facing the traditional software security approaches. According to preferred examples of the present application, the MCU security system first constructs timeseries of behavioral metrics of the MCU and then analyzes the constructed timeseries to determine if the MCUs' behavior is normal or abnormal. A health score of the MCUs' behavior may be calculated based on the analysis. When the health score hits some predefined thresholds, recommended actions may be taken to improve the security of the system.

As can be readily appreciated in the rest of the specification, the present application provides a highly efficient solution to MCU security. Furthermore, the present application provides a solution to some of the most challenging security threats such as the zero-day threats and the cover timing channel communication. The zero-day threats are defined as the treats that do not have any public information and especially do not match any known existing signature. Traditional security approaches are all based on known information of a threat. Thus, the zero-day threats cannot be detected by those approaches. In contrast, the software based MCU security, which may also be called as MicroAI security throughout the specification, detects all threats by using the behavioral information of the computer instead of the threats' information. Those types of threats can be detected effectively using the MicroAI security. Cover timing communication channel is another example that provides challenging issues for cybersecurity, which will be described in more details below in the present application.

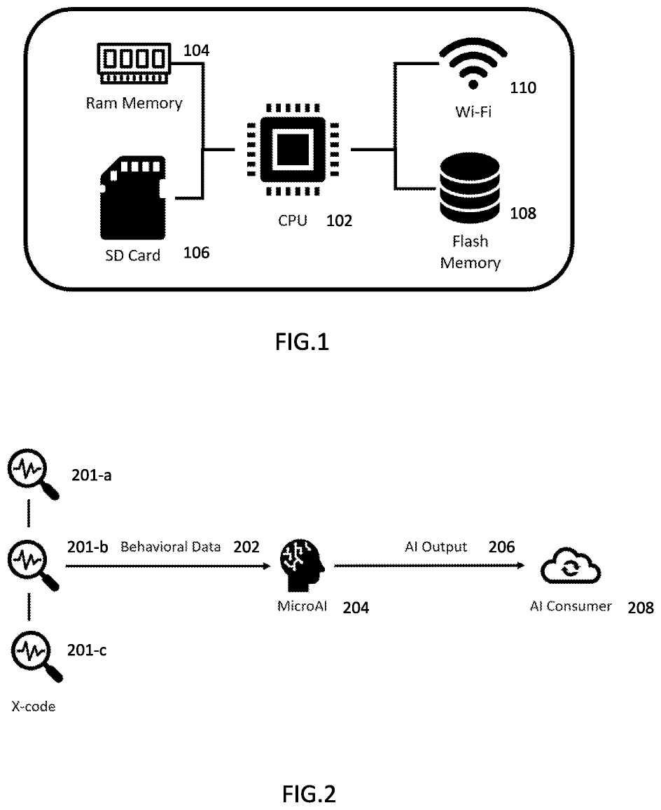

FIG. 1 is a schematic diagram of a single board computer using MCU according to an example of the present application. Referring to FIG. 1, the MCU board 100 includes a CPU 102, a RAM memory 104, an SD card 106, a flash memory 108 and a Wi-Fi unit 110. The CPU 102 of the MCU may typically have a core of 16- or 32-bit, although shorter or longer bits are also available. Memory RAM 104 is a volatile memory for storing short-term data for active tasks of the CPU. Code and/or long-term data may be stored in non-volatile memories such as the SD Card 106 and the Flash memory 108 illustrated in FIG. 1. Wireless connectivity of the MCU may include a Wi-Fi unit 110, and/or other types of wireless units, that wirelessly connects the MCU to the network.

FIG. 2 is an exemplary schematic view of the MCU security data flow. As illustrated in FIG. 2, behavior data 202 are collected from x-codes 201-a, 201-b, 201c. There may be many more x-codes 201 depending on the system. The behavior data may be gathered by sensors interfacing with the x-codes 201. For example, in IoT (Internet of things) applications, specific data regarding the performance, integrity, security and other aspects of smart devices and machines, collectively referred to as behavior data, may be collected.

The behavior data are transmitted to the MicroAI 204, i.e., the software based MCU security system based on AI of the present application. (MicroAI and software based MCU security system are used interchangeably throughout the disclosure.) The MicroAI 204 processes the behavioral data and provides the information to the AI consumer 208. In one example, the AI output 206 is transmitted to the AI consumer 208 in the cloud. In other examples (no illustrated herein), the AI output 206 is consumed by a local AI consumer 208 without dependency on the cloud, wherein it provides real-time security system to the operators of the system. In the example illustrated in FIG. 2, x-code, which is integrated development environment (“IDE”) based on iOS, is used to collect the behavior data. According to other examples, other IDE of that can be configured to provide and transmit the behavioral data to MicroAI 204 may also be used.

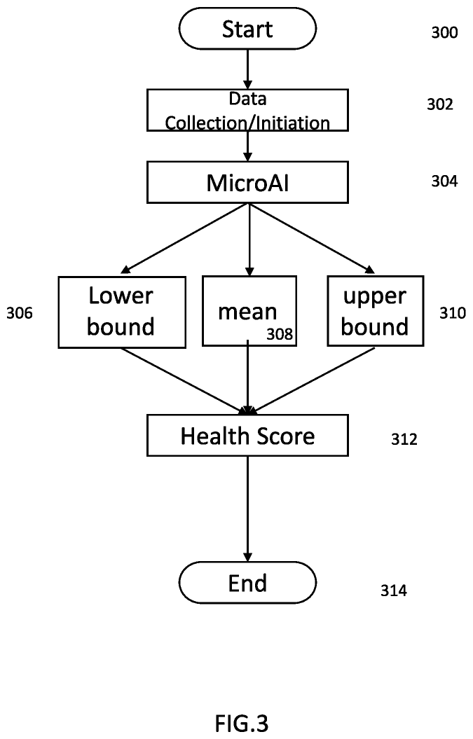

FIG. 3 is a flowchart of the MCU security system of the present application in inference mode. Referring to FIG. 3, after the MCU security system starts at 300, the system will conduct data collection/data initiation in 302. (Data collection and data initiation will be used interchangeably throughout the disclosure.) This step corresponds to the collection of behavior data 202 from the x-code 201s as illustrated in FIG. 2. After the data collection, the MicroAI engine begins at 204 and calculates a lower bound 306, an upper bound 310 and a mean 308 of a range that is considered as a normal behavior range. Comparing to this range, a health score may be derived in step 312. In one example, the lower bound 306, the upper bound 310 and the mean 308 correspond to the AI output 206 in FIG. 2 and the health score derived in step 312 may correspond to the AI consumer in 208 as illustrated in FIG. 2.

The MCU security system of the present application is based on the AI technology. It involves two major steps: training and inference. That is, before the inference may be made as illustrated in FIG. 3, the system needs to be trained with training data. In other words, the MCU security system includes a training module and an inference, or prediction, module. In the rest of the disclosure, the training module and the inference module will be described in turn. Further, as it will be made clear in the disclosure, the initiation is an integral part of the MCU security algorithm and is closely related to the training and inferencing, the initiation module will also be described in the disclosure. Hereafter, the aforementioned three modules will be described in more details.

### The Initiation Module

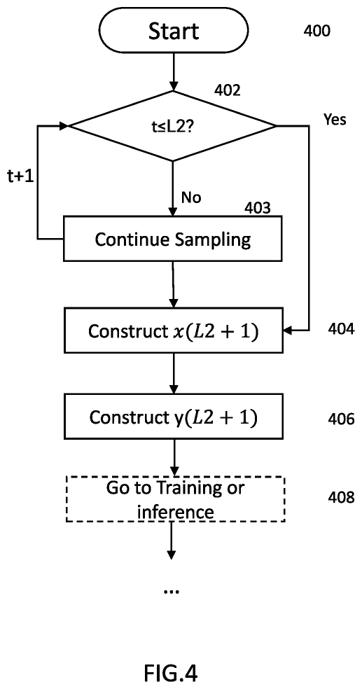

FIG. 4 describe the initiation process of the MCU security system. Referring to FIG. 4, when the MCU board starts at 400, the time interval t is set to zero. According to an example, the time intervals represent a series of sequential time period evenly spaced. Based on the time intervals, the MCU security system updates and processes the system information. For each step that's performed, the time interval will increase by 1. It will become clear that all processed data and the corresponding algorithms of the present application are closely related to the time intervals. As such, those processed or constructed data may also be referred to as timeseries data throughout the specification. The time interval t can be any period of time. According to an example, it is set to one second for all three modules of the MCU security system. Referring back to FIG. 4, at t=1, i.e., the first interval after initiation, all elements of a vector denoted as feature vectors x(t) of the MCU security system are set to 0. The feature vectors x(t) and prediction y(t) are key concepts of the algorithms of the present application. Generally speaking, the feature vectors x(t) are assigned or otherwise contain data that may be used to learn and/or predict the behavior data of the MCU, which is assigned to y(t). y(t) may be referred to as the prediction value, the prediction vector, or simply prediction throughout the present application, as it contains the prediction data either to be learned or to be inferred. More details with regard to x(t) and y(t) are described below.

In the example illustrated in FIG. 4, the total initiation, or sampling intervals, for the initiation is denoted as L2. It also corresponds to the total number of steps needed to be undertaken in the initiation process and the total number of items in the feature vectors x(t) that's initiated. As illustrated in FIG. 4, the initiation algorithm checks if a total number of L2 steps has been performed in step 402. If the sampling has not finished, the algorithm will continue obtaining data from so-called state vectors s(t), which contains the system state data, such as original data collected from the x-code regarding some particular system information and assign the data to the feature vectors x(t).

The algorithm will repeat the sampling steps until the time interval reaches t=L2. Then the algorithm jumps out of the loops of 402 and 403 and stops the sampling steps. Then, it will assign the next x(t) of the timeseries, i.e., x(L2+1) to that of a flatten of all the state value s(t), i.e., x(t) in step 404. Flatten is function that “flattens” two- or higher dimensional matrix data to a lower dimension. In one example, it means that the two-dimension set of [s(1), . . . , s(L2)] may be transformed to a one-dimension dataset.

In other words, the algorithm considers that when t=L2+1, i.e, the x(t) has been filled with the prerequisite number of historical values of the s(t). The step of 404 may be written as:

x(L2+1)=flatten of the [s(1),s(2), . . . ,s(L2)]

The prediction y(t) is given the following value:

y(L2+1)=flatten of s(L2+1)

This is illustrated in step in 406. It is noticed that the x(L2+1) contains the historical system state data up to when t=L2, but y(L2+1) contains the “current” data of the system at t=L2+1. That is, after the initiation, the prediction vector y(t) contains the current status information of the MCU, which is one step ahead of x(t).

After the initiation, a pair of data (x(t), y(t)) for each time interval is constructed. Thereafter, in step 408 the constructed data points ((x(t), y(t)) may be used both in the training module if the historical data is a training set and the inference module if the historical data is real-time data of the system in inference module.

It is noted, the ((x(t), y(t)) dataset may be constructed to correspond to the upper bound, lower bound or the mean regarding a particular system information, depending on the initiation data. In turn, the MicroAI may also infer the lower bound, upper bound and mean in the inference module as illustrated in FIG. 3

### The Training Module

The training module provides for an algorithm to process the training dataset (Xₜᵣₐᵢₙ, Yₜᵣₐᵢₙ) to prepare the MicroAI for inferencing. The training dataset (Xₜᵣₐᵢₙ, Yₜᵣₐᵢₙ) contains training data that has the same meaning of those constructed datasets described in connection with the initiation module. That is, the data Xₜᵣₐᵢₙ captures the historical states of a particular system information or channel of the MCU and the data Yₜᵣₐᵢₙ represents a present state of the system that is one step ahead of Xₜᵣₐᵢₙ.

The purpose of the MCU security system can be described as given a training dataset (Xₜᵣₐᵢₙ, Yₜᵣₐᵢₙ) and a known x, finding the y that is corresponding to the x. However, before the actual interpolation may be done, the present application provides a training module that helps the MCU security system to learn the training data in an efficient way, especially for high dimensional datasets, i.e., when the dataset is long.

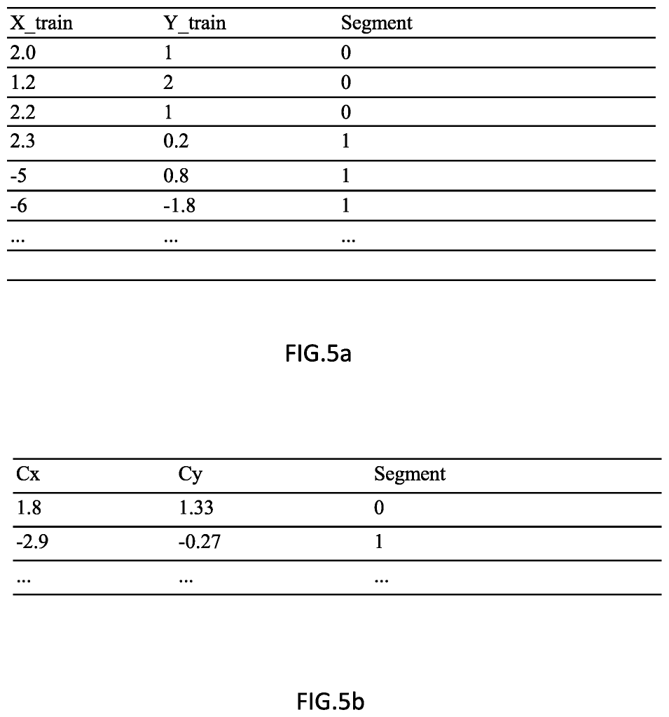

First of all, according to an example, the training dataset is divided into segments of equal length. FIG. 5a illustrates the segmented training set. Referring to FIG. 5a, a training dataset (Xₜᵣₐᵢₙ, Yₜᵣₐᵢₙ) is illustrated therein, each of the training data from X-domain and Y-domain occupies a column. The dataset comprises a long list of paired values, i.e., rows, each representing a dataset point from the training data. On the third column of FIG. 5a, segment sequence numbers are listed therein. In the example depicted in FIG. 5a, each segment includes 3 dataset points, including from segment 0, 1, . . . . The number of dataset points in each segment may be any number but preferred to be a small number suitable for the computational resource of an MCU. In this example, the number 3 may also be referred to as the L3 number and will be described in more details below.

To further simplify the training data to suit the constraints of the MCUs, the datapoints of each segment may be further reduced to a single datapoint. According to an example, for each segment, a “center” may be calculated. It may be calculated using a simple Mean function of the data in the segment. As illustrated in FIG. 5b, the centers of each data segment are calculated. That is, in the segment 0 of FIG. 5a, the Xₜᵣₐᵢₙ data including 2.0, 1.2 and 2.2 are added together and divided by 3, and the new entry in FIG. 5b denoted as Cₓ is 1.8 for segment 0. Similarly, the Xₜᵣₐᵢₙ of segment 1 in FIG. 5a, i.e., 2.3, −5 and −6 are averaged to −2.9, which is added in FIG. 5b as the Cₓ for segment 1. Same operations on Yₜᵣₐᵢₙ are also performed. The mean of 1.33 of segment 0's Yₜᵣₐᵢₙ is entered into the C_{y} corresponding to Segment 0 in FIG. 5b. Similarly, the Yₜᵣₐᵢₙ of segment 1 in FIG. 5a is averaged to −0.27 and entered into as Cy of segment 1 in FIG. 5b.

There are several advantages of using the center points of data segments as described above. First, it reduces the size of the datasets by a chosen factor, e.g., 3, in the examples illustrated in FIG. 5a-5b, which enlarges the total information that may be learned by an MCU security system. Further this algorithm may be used in high dimensional datasets, where the datapoints may be vectors instead of numbers. In high dimensional scenarios, instead of calculating a mean value of a set of numbers, the mean value of a set of vectors can also be used using traditional algorithms know in the art.

Another important advantage of using the center point algorithm is that it can be implemented recursively on the MCU. Especially for a sequential of vectors x(1), x(2), . . . x(k) . . . , the mean value of the first k vectors can be calculated by using the below equations:

$$mean ( 0 ) = 0$$

$$mean ( k ) = \frac{mean ( k - 1 ) ⋆ ( k - 1 )}{k + x ( k ) / k}$$

$$for k = 1 , 2 , 3 , …$$

The above equation can be proved by using the mathematical induction without difficulty, because:

(k+1)*mean(k+1)=x(1)+x(2)+ . . . +x(k+1)=mean(k)*k+x(k+1) therefore,

$$mean ( k + 1 ) = \frac{k * mean ( k ) + x ( k + 1 )}{k + 1}$$

The above proof implies that if the x(1), x(2), . . . x(k), . . . is a time series with vector value, the mean of them till t=k can be calculated by using fixed size memory. Being able to calculate the mean recursively is a feature highly advantageous for implementing the algorithm in an MCU of limited computation resources.

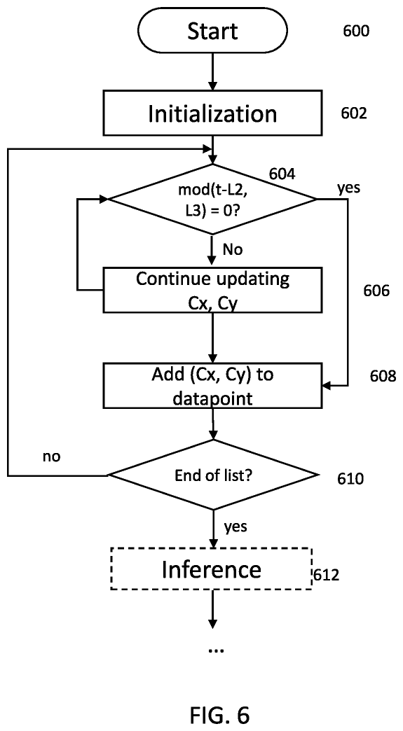

Referring to FIG. 6, the learning process of the present application is illustrated therein in step 602, the learning module takes the initialized data and find the center of the dataset as described in connection with FIGS. 5a-5b. Step 604 will check if the current segment of data is all in by checking the information related to L3, which is the length for each segment. When the segment is not exhausted, the learning algorithm will continue update the temporary Cx and Cy in step 606. When all the data in the segment is in, the algorithm will add the finalized the Cx and Cy as a datapoint 608. The process continues until all data are processed as illustrated in 610. After that, the trained MCU security system may start the inference process in Step 612. The inference process is described in more details below.

### The Inference Module

The inference module, or prediction module, is the module where the MicroAI go live on real-time data and predict if the MCU is in a normal state or an abnormal state, based on the training data.

As described above, the function of the AI-based MCU security system can be described as given a training dataset (Xₜᵣₐᵢₙ, Yₜᵣₐᵢₙ) and a known x, finding the y that is corresponding to the x. As iterated before, the known x captures the historical states of a particular system information or channel of the MCU in operation, and y is the prediction based on x after the MCU AI engine has been trained by the dataset (Xₜᵣₐᵢₙ, Yₜᵣₐᵢₙ). Persons skilled in the art may appreciate that this pertains to an interpolation problem and can be solved by using interpolation algorithms in the prior art. However, because of the computational costs of traditional interpolation algorithms, a lightweight classifier algorithm according to an example of the present application is introduced first.

According to the example of the present application, the inference algorithm runs with the centered data illustrated in the training module. More specifically, after obtaining the (Cₓ, C_{y}), a multi-dimension interpolation equation may be used to calculate the y for a given x. Let Cₓ (1), Cₓ (2), . . . and the C_{y} (1), C_{y} (2), . . . denote the rows of the data set Cₓ and C_{y}.

First, the center interpolation function (“CIF”) is defined. The CIF is a function ƒ(x). The CIF for a function ƒ(a, b) of two vectors:

ƒ(a,b)→positive infinity when x→Cₓk

ƒ(a,b)=finite positive values for other cases.

There could be many such functions. For example, 1/|a−b|. We used the below function:

CIF(a,b)=1/(exp(|a−b|)−1)

As such, for given datasets (Cₓ1, C_{y}1), (Cₓ2, C_{y}2), . . . , and the given vector x, the predicted y corresponding to the x is calculated by using the below interpolation equation (“Equation (1)”):

y=ƒ(x)=[C_{y}1*CIF(x,Cₓ1)+C_{y}2*CIF(x,Cₓ2)+ . . . ]/[CIF(x,Cₓ1)+CIF(x,Cₓ2)+ . . . ]
where clearly, ƒ(Cₓk)=C_{y}k

Further, to avoid the zero-division error in the implementation, we used the below CIF function:

CIF(a,b)=1/(exp(|a−b|)−1+very small positive number)
where the very small positive number may be provided in many ways, e.g., 1e−20.

According to another example of the present application, the center interpolation algorithm may be adapted in a stream version. As illustrated in FIG. 5a, for a given sets of vectors (Xₜᵣₐᵢₙ, Yₜᵣₐᵢₙ), the steps of the algorithm inferring the y for a specific vector x includes Step 1. Calculate the Cₓ and C_{y}, where the parameter of segment row size is determined; and Step 2. Calculate the y by using the interpolation Equation (1).

Both steps may be implemented recursively for streaming data or vector valued time series. Denoting x(t) and y(t) as the input and output time series and denoting the training time window length as L1, the dataset x(1), . . . x(L1) and y(1), . . . y(L1) are used to calculate the Cₓ and C_{y}. Then, for any t>L1, then y(t) can be calculated by using the Equation (1).

Using the lightweight classifier algorithm, an example of inference module of the MCU security system is provided. As described elsewhere and reiterated here, s(t) denotes the behavior state of the MCU, where t=1, 2, 3, . . . . According to an example of the present application, k is chosen to be greater than L2.

As described above, during the training process, for each time=k−1, define the x(k) and y(k) as:

y(k)=s(k)

x(k)=the flatten vector of [s(k−L2), . . . ,s(k−1)] when k>L2
where L2 is the length of the training set.

In the training module, when t=L2+1, Cₓ and C_{y} are constructed. During the inference stage, the x(t) is constructed the same way, which also starts at t=L2+1. In the inference module, values/vectors of the prediction are denoted as s_pred(k). Using the lightweight classifier in Equation (1), s_pred(k) can be calculated.

The y_pred(k)=s_pred(k) will be calculated at time=k−1. Therefore, a one-step-ahead predictor of s(k) is constructed.

For each time=k, the error of the prediction may be calculated as:

error(k)=s_pred(k−1)−s(k−1) when k>1.

error(1)=0 when k=1

Based on the time series error (1), error (2), . . . , we can estimate the mean and variance by using the below equation:

error_mean(k)=error_mean(k)*P1+error(k)*(1−P1)

var_mean(k)=var_mean(k)*P2+error(k)\hat{ }2*(1−P2)
P1 and P2 may be set at 0.9 in one example.

Then, for t=k, the standard derivation can be estimated as:

std(k)=sqrt(var_mean(k))

The mean estimation of s(k) is calculated by using the equation:

s_mean_est(k)=s_pred(k)−error(k)

Then, in each time=k, we can calculate the Security Health Score of the MCU.

According to an example of the present application, the inference module calculates a “health score” based on the predicted state of the MCU system. The health score of a system is akin to the probability of the “health” or “normalcy” of the MCU's behavior. Since the MCU's behavior is represented by the timeseries constructed in a way described above, the health score can be obtained by using the timeseries' statistic properties. For each type of the various of system information, the MCU algorithm may select one or more of the system information and perform same algorithm on them. Different sets of system information may be grouped to reflect a particular aspect of the system.

For example, the system information regarding the CPU usage, used memory and CPU temperature can be grouped to a System Metrics Channel (may be denoted as H_sys); the number of tasks and used SD card space can be grouped into an Application Metrics channel (maybe denoted as H_app); the packet sent and packet received can be grouped into a Network Metrics Channel (may be denoted as H_net). Such grouped system information together may be viewed a “channel” reflecting the health of the MCU with regard to such a channel.

As illustrated above, the inference module can calculate the mean (Mᵢ) and standard deviation (Sᵢ) for each timeseries of the ith channel. As such, the health score of each channel is calculated by using the below equation:

$${k}_{i} = \frac{abs ( {x}_{i} - {M}_{i} )}{{S}_{i}}$$

where abs ( ) is an absolute function.
if kᵢ<1, health score Hᵢ=1 is assigned to this channel.
if kᵢ≥1, then a Health score Hᵢ=1/kᵢ is assigned to the ith channel.

That is, if kᵢ<1, the algorithm considers the channel is healthy and gives a perfect score of 1 to the channel. Otherwise, the channel is considered to be less than healthy and a number that is the inverse of kᵢ is assigned to the channel.

According to an example of the present application, the output actions may be triggered by the H_sys, H_app, and the H_net. More specifically, when one of those health scores is lower than a threshold, e.g., 0.6, the s vector may be saved in a log file with the below format [timestamp, s(t), H_sys, H_app, H_net], or other suitable formats.

Also, a warning signal may be sent to the monitoring server. For example, if one of those health scores is lower than 0.3, the above data may be logged and an urgent warning signal may be sent to the monitoring server.

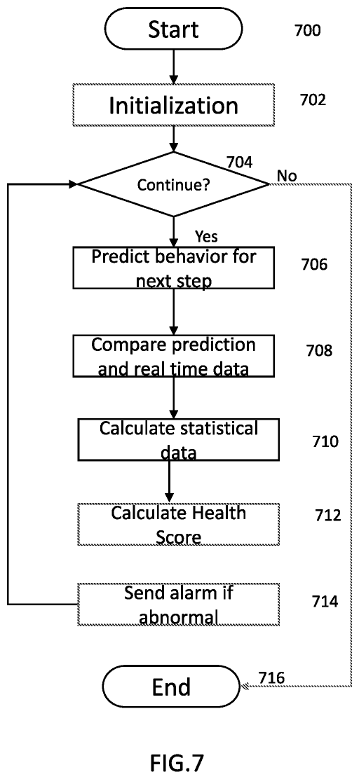

FIG. 7 illustrates the inference process according to an example of the present application. Referring to FIG. 7, in step 702, the vectors are initiated in the same way as in the initiation module described in FIG. 3. After the behavior and prediction vectors are initialized, the inference starts. In the loop starting at 704, the y_pred(k)=s_pred(k) is calculated for the time k−1 in step 706. In step 708, the prediction of s_pred(k) and the real time s(k) are compared. In step 710, various statistical data regarding the error between s_pred(k) and s(k) can be calculated. In Step 712, the health score can be calculated as described above. Thereafter, in step 714, if abnormality in health score is detected, alarm may be sent to monitoring devices, such as a server. The inference for each time interval will continue until some conditions are met in step 704 and ends in step 716 if not.

### Use Cases

The MCU security system may have use cases. One use case is in the field of cyber security. While cyber security is rapidly developing to address all kinds of cyber security threats, hackers are always looking for new ways of hacking the system. A sophisticated and hard to detect hacking method uses what is called a “covert channel” to secretly transmit data.

A covert channel is a communication channel that uses existing recourses to transmit data in a way that was not originally designed for and hard to detect. For example, a covert timing channel may be a legitimate channel for communication. However, hackers may use this the channel to transmit data in a specific timing to convey messages that are not reflected by the content of the data. For example, 200 milliseconds interval between two messages may represent 1, and 100 millisecond differences between two messages as 0. A combination of different timing between messages can transmit any binary information. The binary data can be decoded to human or machine-readable messages by the receiver.

Covert timing channel communication exhibit different statistical properties than normal communications. Because the covert message is carried by the timing information of the communication, communication tends to be neatly scattered in a pattern. Therefore, the regularity and randomness of the time information of the communication can provide insights to the whether there is covert timing communication.

Because the timing information of the communication is key to detect covert timing channel, the time difference between each communication is collected and their statistical properties of the data are calculated. The communication to be monitored can be any type of communication. For example, it can be computer network communication or other communications.

In a computer network, the very basic unit that carries the message of communication is known as a packet. A packet can carry a maximum of 65,535, bytes of data. For covert timing communication, the payload of the packet itself is irrelevant, because the cover message is coded in the timing of a series of packets. To capture the statistical information on the timing of the series of packets, the MicroAI engine can be configured to monitor at least one of the following: 1. Standard deviation of the time differences of send time between packets of a running window; 2. Standard deviation of the time difference of receive time between packets of a running window; 3. Entropy of the time difference of send time between packets of a running window: and 4. Entropy of the time difference of receive time between packets of a running window.

For a given set of packet timing difference data X, the standard deviation (a) of set

$$σ = \sqrt{\frac{{Σ ( {x}_{i} - μ )}^{2}}{N}}$$

where xᵢ is the timing difference between two consecutively received packets.
μ is the mean of set S.
N is the total number of values in set S.

For the given set of packet timing difference data X, the entropy of set X denoted as H(X), is calculated as:

$$H ( X ) = - {\sum }_{i = 1}^{n} P ( {x}_{i} ) {log}_{m} P ( {x}_{i} )$$

where P(xᵢ) is the probability of value xᵢ.
m is the base of the log. It can be 2, 10, or e.

The standard deviation value and the entropy vale may be fed to the MicroAI algorithm. Training and referencing may follow the standard MicroAI security procedures. In a traditional solution that detects covert timing channels, the standard deviation and entropy threshold will be manually set based on domain knowledge. But with MicroAI Security, the AI will learn the normal range of those values and dynamically adjust the threshold to fit the unique environment.

Another use case of the MicroAI is to monitor a specific set of system behaviors that are related to ransomware attack. Below is a list of data MicroAI monitors. These values will be feature engineered and feed to MicroAI timeseries machine learning AI engine.
number of files that were renamed during the last period of time.
number of files that were deleted during the last period of time.
number of files that were created during the last period of time.
number of newly created files that are encrypted.

Any significant deviation on these channels will trigger an alert. Training and inferencing will follow the standard MicroAI security procedure.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like, whether or not qualified by a term of degree (e.g., approximate, substantially, or about), may vary by as much as ±10% from the recited amount.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

What is claimed is:

1. A software based MCU security system monitoring system information, comprising:
a training module configured to process a plurality of training dataset; and
an inference module configured to predict a current behavior state of the MCU based on the processed training dataset and a past behavior state, wherein the current behavior state is one step ahead of the past behavior state.

2. The system of claim 1, wherein at least one health score is calculated based on statistical metrics derived from differences between the predicted current behavior state and a real-time current behavior state of a channel, said channel comprises related system information.

3. The system of claim 2, wherein the channel comprising at least one of a system metrics channel, an application metrics channel and a network metrics channel.

4. The system of claim 1, wherein the predicted current behavior state includes at least a lower bound, an upper bound and a mean of the current state.

5. The system of claim 1, wherein the prediction of the current behavior state is based on a lightweight classifier algorithm, said light weight classifier algorithm is configured to calculate a center of a segment of the training dataset, said calculation is configured to run recursively.

6. The system of claim 1, further comprising:
an initiation module, said initiation module is configured to initiate the training module and the inference module.

7. The system of claim 1, wherein the monitored system information is related to a detection of a cover channel communication, and wherein the predicted current behavior state and the past behavior state are related to at least one of a standard deviation of the packet timing difference and an entropy of a communication.

8. The system of claim 1, wherein the monitored system information is related to a detection of ransomware, and wherein the predicted current behavior state and the past behavior state are related to at least one of a number of files that were renamed during a last period of time, a number of files that were deleted during the last period of time, a number of files that were created during the last period of time, and a number of newly created files that are encrypted.

9. A method of monitoring system information by an MCU security system, comprising:
training by training module of the MCU security system configured to process a plurality of training dataset;
inferring by an inference module configured to predict a current behavior state of the MCU based on the processed training dataset and a past behavior state, wherein the current behavior state is one step ahead of the past behavior state.

10. The method of claim 9, wherein at least one health score is calculated based on statistical metrics derived from differences between the predicted current behavior state and a real-time current behavior state of a channel, said channel comprises related system information.

11. The method of claim 10, wherein the channel comprising at least one of a system metrics channel, an application metrics channel and a network metrics channel.

12. The method of claim 9, wherein the predicted current behavior state includes at least a lower bound, an upper bound and a mean of the current state.

13. The method of claim 9, wherein the prediction of the current behavior state is based on a lightweight classifier algorithm, said light weight classifier algorithm is configured to calculate a center of a segment of the training dataset, said calculation is configured to run recursively.

14. The method of claim 9, further comprising:
an initiation module, said initiation module is configured to initiate the training module and the inference module.

15. The method of claim 9, wherein the monitored system information is related to a detection of a cover channel communication, and wherein the predicted current behavior state and the past behavior state are related to at least one of a standard deviation of the packet timing difference and an entropy of a communication.

16. The method of claim 9, wherein the monitored system information is related to a detection of ransomware, and wherein the predicted current behavior state and the past behavior state are related to at least one of a number of files that were renamed during a last period of time, a number of files that were deleted during the last period of time, a number of files that were created during the last period of time, and a number of newly created files that are encrypted.

17. A software based MCU security system of a network, comprising:
a plurality of nodes collecting at least one set of behavior data pertaining to system metrics;
an AI engine configured to predict if the network is having normal behavior, wherein if abnormal behavior is detected, an alarm is sent to an AI consumer.

18. The system of claim 17, wherein the AI engine comprising:
a training module configured to process a plurality of training dataset; and
an inference module configured to predict a current behavior state of the MCU based on the processed training dataset and a past behavior state, wherein the current behavior state is one step ahead of the past behavior state.

19. The system of claim 17, wherein the abnormal behavior is detected by determining a health score of the network.

20. The system of claim 17, wherein the at least one set of behavior data are related to at least one of a cover timing channel communication and ransomware.
